(19) United States
(12) Patent Application Publication
(10) Pub. No.: US 2008/0085623 A1
(43) Pub. Date: Apr. 10, 2008

(54) Lampholder for double-ended lamp

(76) Inventors: Michael F. Scholeno, York, PA (US); Shane Brown, York, PA (US); Jack Burwick, York, PA (US)

Correspondence Address: OSRAM SYLVANIA INC, 100 ENDICOTT STREET, DANVERS, MA, 01923, US

(21) Appl. No.: 11/544,967

(22) Filed: Oct. 6, 2006

(51) Int. Cl. H01R 13/64

(52) U.S. Cl. 439/375

(57) ABSTRACT

A socket (10) for a double-ended lamp has a housing (12); a compression spring (14) within the housing (12); a lamp connector (16) comprising a body (18) with a first portion (20) contained entirely within the housing (12) and a second portion (22) extending beyond the housing (12) and having a given length L, the lamp connector (16) being subjected to an axial movement when a lamp is operatively positioned with the socket (10), the axial movement having a maximum distance AL that is less than the given length L.

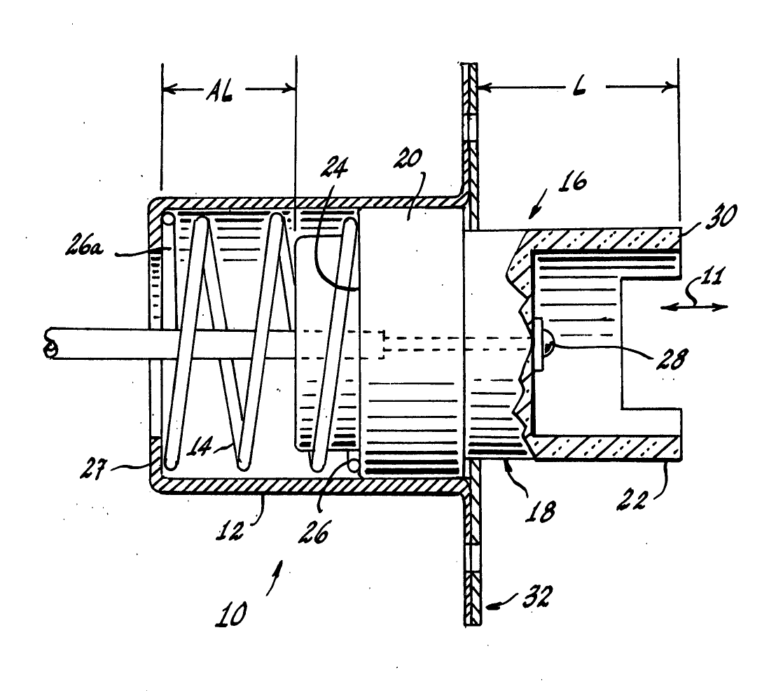

### TECHNICAL FIELD

This invention relates to lampholders and particularly to lampholders for double-ended lamps. Still more particularly, it relates to lampholders (e.g., sockets) for double-ended lamps that have more efficient operation.

### BACKGROUND ART

Lampholders for some double-ended lamps have comprised a metal housing containing a slidable ceramic body therein. A portion of the ceramic body extends from both ends of the housing and one end of the body is formed to receive, hold, and supply electrical power to an inserted lamp. It was often the case, when inserting a lamp, that the lamp-receiving portion of the body would penetrate the housing to too great an extent and become wedged in the housing. This problem created considerable downtime when changing lamps and resulted in extra costs associated with the lamp replacement.

### DISCLOSURE OF INVENTION

It is, therefore, an object of the invention to obviate the disadvantages of the prior art.

It is another object of the invention to enhance sockets for double-ended lamps.

These objects are accomplished, in one aspect of the invention, by a socket for a double-ended lamp that comprises a housing, a compression spring within the housing; a lamp connector comprising a body with a first portion contained entirely within the housing and a second portion extending beyond the housing and having a given length L, the lamp connector being subjected to an axial movement when a lamp is operatively positioned with the socket, the axial movement having a maximum distance that is less than the given length.

### BRIEF DESCRIPTION OF THE DRAWINGS

The single FIGURE is an elevational view, partially in section, of an embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawing with greater particularity, there is shown a socket 10 for a double-ended lamp (not shown) that comprises a housing 12 having a compression spring 14 within the housing 12. The housing 12 can be constructed of a suitable metal.

A lamp connector 16 has a body 18 of a suitable electrically insulating material, such as a ceramic, is fitted within the housing 12. A first portion 20 of the body 18 is contained entirely within the housing 12 and a second portion 22 extends beyond the housing 12 and has a given length L. The lamp connector 16 is subjected to an axial movement (see arrow 11) whenever a lamp is inserted or withdrawn. The axial movement has a maximum distance AL that is less than the given length L, thus preventing the leading edge 30 of the second portion 22 from being constrained within the housing.

The first portion 20 of the body 18 includes a flange 24 that is in contact with a first end 26 of the compression spring 14. The other end 26a of the compression spring 14 is held against a housing flange 27.

An electrically conductive lamp contact 28 is fixed in the body 18, as is known.

For mounting purposes a mounting bracket 32 is provided affixed to the housing 12.

Thus there is provided a new and improved socket for double-ended lamps. The socket is smaller and less cumbersome than those of the prior art and additionally makes jamming of the lamp-receiving portion of the connector body within the housing an impossibility.

While there have been shown and described what are at present considered to be the preferred embodiments of the invention, it will be apparent to those skilled in the art that various changes and modifications can be made herein without departing from the scope of the invention as defined by the appended claims.

1. A socket for a double-ended lamp comprising:
a housing;
a compression spring within said housing;
a lamp connector comprising a body with a first portion contained entirely within said housing and a second portion extending beyond said housing and having a given length L, said lamp connector being subjected to an axial movement when a lamp is operatively positioned with said socket, said axial movement having a maximum distance AL that is less than said given length L.

2. The socket of claim 1 wherein said first portion includes a flange in contact with an end of said compression spring.

3. The socket of claim 1 wherein said body is electrically insulating and contains mounted therein an electrically conductive lamp contact

4. The socket of claim 1 wherein said housing includes a mounting bracket.
